(19) United States
(12) Patent Application Publication
(10) Pub. No.: US 2007/0242067 A1
(43) Pub. Date: Oct. 18, 2007

(54) SmartForm

(75) Inventors: Shrikant B. Sharma, Totterdown (GB); Ian Liddell, Sudbury (GB)

Correspondence Address: WILMER CUTLER PICKERING HALE AND DORR LLP, 60 STATE STREET, BOSTON, MA, 02109, US

(73) Assignee: Buro Happold Limited, Bath (GB)

(21) Appl. No.: 11/406,515

(22) Filed: Apr. 18, 2006

(51) Int. Cl. G06T 15/30

(52) U.S. Cl. 345/423

(57) ABSTRACT

A method of determining points on a three-dimensional surface, comprising determining a plurality of first points on a first curve on the surface; determining a plurality of second points on a second curve on the surface; determining a further point in a set of further points, wherein the further point is associated with associated points, and the associated points comprise: at least one first point and at least one second point; at least one first point and at least one point in the set of further points; at least one second point and at least one further point in the set of further points; or a plurality of further points in the set of further points.

This invention relates to a data processing system and method.

### BACKGROUND TO THE INVENTION

Modern building structures often include unusual three-dimensional shapes for part or all of the structure. The three-dimensional part can include, for example, doubly curved surfaces. The three-dimensional part must generally be designed before being included in the plans for the structure.

Computer aided design (CAD) techniques can be used to define doubly curved surfaces, where a physical model does not necessarily exist. A doubly curved surface is a three-dimension surface which appears curved, not flat, when following any direction along a surface. Thus, for example, a cylinder is not a doubly curved surface as when following the axial direction along the surface, the surface appears flat, not curved, and a straight line is followed.

These CAD techniques typically involve providing a mechanism by which an architect or a designer defines a curve using a set of points, and a surface using a set of curves. The CAD software internally stores the curve and surface models as parametric mathematical equations. Once the surface has been fully defined according to the architect's wishes, the computer model then gets passed onto engineers who, working with the architects, define the physical layout, materials and properties of the structure that will provide and support the form of the three-dimensional surface, scaled as appropriate. This process is usually complex, and iteratively passed between the engineers and architects until a final structure plan is agreed upon.

Typically, the engineers focus on coming up with a physical structure that is possible to construct, not necessarily conforming to the form of the three-dimensional surface that the architect specified. For instance, if an architect specifies an ellipsoidal form for a roof that is to be built out of timber, the engineer might start with a flat timber grid. The engineer would then raise the grid in the centre, resulting in a grid-shell that is approximately of the ellipsoidal form intended. Similarly, if the architect specifies a doubly-curved glass façade that is to be build out of flat 4-sided panels, one solution chosen by the engineers would be to use a ‘translated arch’ method, described below, to provide a shape close to or approximating the architect's intended form. In the majority of cases, the methods used lead to a great degree of simplification and deviation from the form provided by the architect, and also result in a large number of iterations and inefficiencies and wastage associated with them.

In the translated arch method, a piecewise linear curve is specified. A piecewise linear curve is a ‘curve’ which is made up of a number of short straight lines. The specified curve is translated along a spine curve which is also piecewise linear, resulting in a piecewise flat approximation to a doubly curved three-dimensional surface which is made up of flat 4-sided panels. This method however limits flexibility as the form of the three-dimensional surface is a direct result of the translation. The designer or engineer can vary the translated curve and spine curve but does not have complete freedom over the final form.

FIG. 1 shows an example of a three-dimensional surface 10 produced using the translated arch method. A first piecewise linear curve 12 is specified. This is then translated along a second piecewise linear curve 14. The resulting surface 10 comprises a plurality of flat 4-sided panels 16.

### SUMMARY OF THE INVENTION

According to a first aspect of embodiments of the invention there is provided a method of determining points on a three-dimensional surface, comprising determining a plurality of first points on a first curve on the surface, determining a plurality of second points on a second curve on the surface and determining a further point in a set of further points, wherein the further point is associated with associated points, and the associated points comprise at least two points from the plurality of first points, the plurality of second points and/or the set of further points.

Thus a user may specify virtually any three-dimensional surface and embodiments of the invention provide a plurality of points on the surface. These points may be converted to panels with corners at the points, or grid shell members with ends at the points, which can then be constructed. Embodiments of the invention therefore determine a buildable structure which corresponds to virtually any three-dimensional surface, with little or no deviation from the surface specified by the user.

Other aspects of embodiments of the invention are defied in the appended claims.

### BRIEF DESCRIPTION OF THE DRAWING

Embodiments of the invention will now be described, by way of example only, with reference to the accompanying drawings in which:

FIG. 1 shows a three-dimensional surface generated using the known translated arch method;

FIG. 2 shows a process of converting a three-dimensional surface to a plurality of cells according to embodiments of the invention;

FIG. 3 shows process of defining a plurality of cells according to embodiments of the invention;

FIG. 4 shows an example of a three-dimensional surface with a stating point;

FIG. 5 shows an example of a three-dimensional surface with generating curves passing through the starting point;

FIG. 6 shows an example of a parametric representation of a curve;

FIG. 7 shows an example of a parametric representation of a three-dimensional surface;

FIG. 8 shows an example of a three-dimensional surface where a number of points have been identified on the generating curves;

FIG. 9 shows an example of a three-dimensional surface where a number of further curves have been determined, passing through some of the points on the generating curves;

FIG. 10 illustrates an example of a process for finding a fourth point in a cell from three other points;

FIG. 11 shows a three-dimensional surface that has been completely converted into cells according to embodiments of the invention;

FIG. 12 shows an example of cell merging according to embodiments of the invention;

FIG. 13 shows an example of a cell;

FIG. 14 shows an example of a non-planar cell;

FIG. 15 shows an example of another three-dimensional surface with a starting point, generating curves, points on the generating curves, further curves passing through some of the points on the generating curves, and further points defined on the further curves;

FIG. 16 shows an example of another three-dimensional surface with a starting point, generating curves, points on the generating curves, and further curves passing through some of the points on the generating curves;

FIG. 17 shows an example of the three-dimensional surface of FIG. 16 when converted into cells according to embodiments of the invention;

FIG. 18 shows an example of the three-dimensional surface of FIG. 16 when converted into cells according to embodiments of the invention;

FIG. 19 shows an example of the three-dimensional surface of FIG. 16 when converted into cells according to embodiments of the invention;

FIG. 20 shows an example of a three-dimensional surface where curves of intersection are defined on the surface;

FIG. 21 shows all example of a three-dimensional surface that has been converted into cells according to embodiments of the invention;

FIG. 22 shows a process for defining a plurality of cells according to embodiments of the invention;

FIG. 23 illustrates an example of a process for defining a fourth point in a cell from two or three other points;

FIG. 24 shows an example of a three-dimensional surface that has been converted into cells according to embodiments of the invention;

FIG. 25 shows an example of 4-sided cells which have been divided into triangular cells using triaxial mapping; and

FIG. 26 shows an example of a grid shell structure constructed from grid shell members defined according to embodiments of the invention.

### DETAILED DESCRIPTION OF EMBODIMENTS OF THE INVENTION

Embodiments of the invention provide a method of converting any three-dimensional surface, including doubly curved surfaces, into a design of a structure. The structure can then be constructed according to the design to produce a structure having substantially the same shape as the three-dimensional surface.

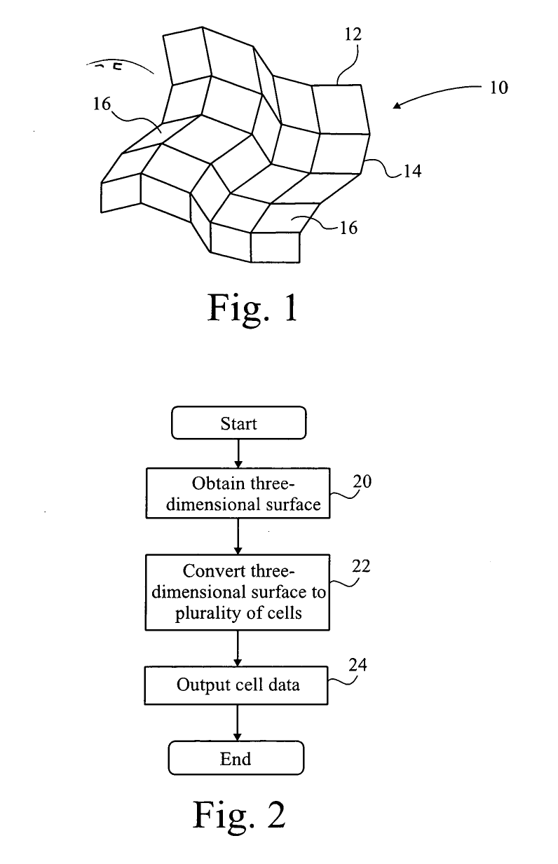

FIG. 2 shows a flow chart of steps which are undertaken by software implementing a method according to embodiments of the invention. In step 20, a definition, description or representation of the three-dimensional surface is obtained. This is predetermined by a designer of a structure, or a part of the structure which is to conform to the three-dimensional surface. The three-dimensional surface is preferably specified using NURBS (Non-Uniform Rational B-Splines), an industry standard for representation of curves and three-dimensional surfaces. Further information on NURBS can be found in Farin, G. “Curves and surfaces for computer aided geometric design”, 3rd Edition, Academic Press, USA, 1992 and Mortenson, M. E. “Geometric modelling”, 2nd Edition, Wiley Computer Publishing, New York, 1997. These references are incorporated herein by reference in their entirety for all purposes. Other representations of a three-dimensional surface e.g. Bezier, Hermite-Spline, etc. are possible.

In step 20, the definition, description or representation of the three-dimensional surface may be obtained, for example, from CAD (computer-aided design) software, such as IGES, DXF and Rhino 3DM. In certain embodiments, a user may be able to design a three-dimensional surface using software according to embodiments of the invention.

In step 22, which follows from step 20, the three-dimensional surface is converted into a plurality of cells as described in more detail below. In step 24, which follows from step 22, the software outputs cell data which contains information about the cells found in step 22.

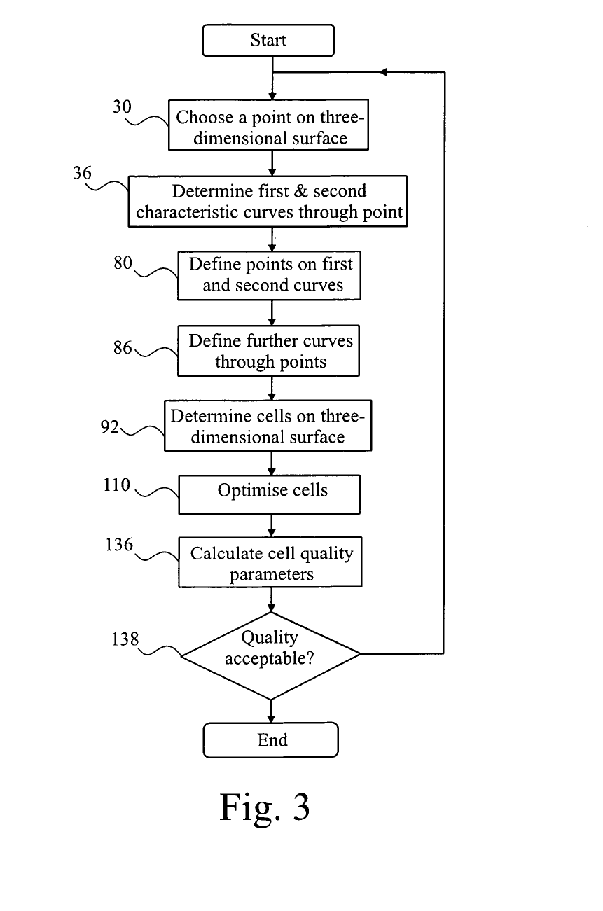

The step 22 of converting the three-dimensional surface into a plurality of cells is shown in more detail in the flow chart of FIG. 3. Firstly, in step 30, a point is chosen on the three-dimensional surface. This is done by the user, for example, by the user graphically choosing a point on a computer screen. Alternatively, the point can be chosen by the software, and can be, for example, the highest point on the three-dimensional surface, a corner, a randomly chosen point or any other point. The position of the point chosen in step 30 may have some impact on the cells produced, such as, for example, the number, size, shape and/or planarity of the cells.

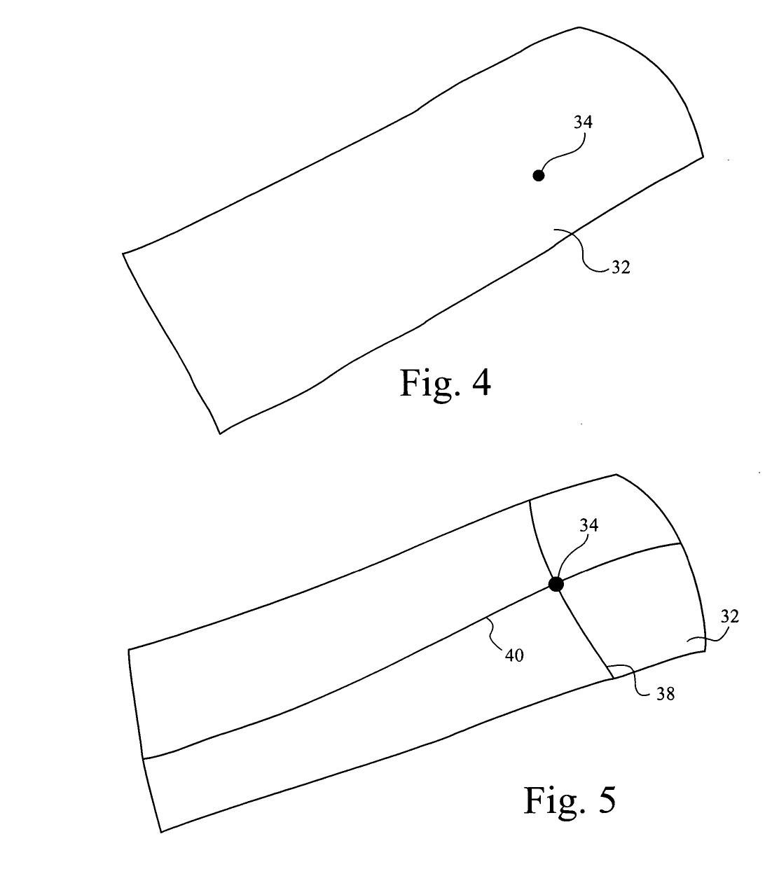

FIG. 4 shows an example of a three-dimensional surface 32. A point 34 on the surface 32 has been chosen in step 30.

Referring back to FIG. 3, in step 36, which follows from step 30, first and second generating curves are determined which pass through the point 34 chosen in step 30.

Generating curves are curves of a type specified by user of the software which lie on the three-dimensional surface. Examples of types of curve include, among others, lines of curvature, geodesic curves and curves of intersection between the three-dimensional surface and a plane.

FIG. 5 shows the surface 32 with two example generating curves 38 and 40 passing through the point 34. In this example, the generating curves 38 and 40 are the two lines of curvature through the point 34. The two generating curves do not have to be the same type of curve.

Consider that there are an infinite number of curves which pass through the point 34. Each of these curves has a curvature at the point 34. The curvature of one of the curves at the point 34 has a magnitude equal to the reciprocal of the radius of an osculating circle (a circle that “kisses” or closely touches the curve at the given point), and is a vector pointing in the direction of that circle's centre. It can be appreciated that at the point 34, the osculating circle and the curve share a common tangent. It can be appreciated that for straight lines, the radius of the osculating circle is infinity and therefore the curvature is zero. The value of the curvature may vary along the curves. However, only the value at the point 34 is considered.

All curves that pass through the point 34 and share a common tangent at the point 34 have the same curvature at the point 34. Therefore, when considering curvature at the point 34, it is sufficient only to consider, for example, a curve of intersection between the three-dimensional surface 32 and an intersecting plane containing the normal vector to the surface at the point 34. This may be simpler than considering a more complex curve which passes through the point 34 and shares a common tangent with the curve of intersection. The intersecting plane forming the curve of intersection can be rotated about an axis containing the normal vector to the surface at the point 34. As the plane is rotated, the curvature of the curve of intersection at the point 34 exhibits a maximum and a maximum. The tangents to the surface 32 at the point 34 which lie in the plane, when the plane is at positions corresponding to maximum and minimum curvatures, are called the principal directions. At any point on the surface 32, the principal directions are normal (i.e. at right angles) to each other.

A line of curvature is a line on a three-dimensional surface which always follows one of the principal directions.

Curves can be described mathematically in non-parametric and parametric forms. For a non-parametric curve, usually the coordinates y and z of a point on the curve are expressed as two separate functions of the third coordinate x as the independent variable. For a parametric curve, a parameter u is introduced and the coordinates (x, y, z) are expressed as functions of u. The following is an expression of a parametric curve C(u):

$$C ( u ) = \{ \begin{matrix}x \\ y \\ z\end{matrix} \} = \{ \begin{matrix}x ( u ) \\ y ( u ) \\ z ( u )\end{matrix} \} , {u}_{min} \leq u \leq {u}_{max} \qquad ( 1 )$$

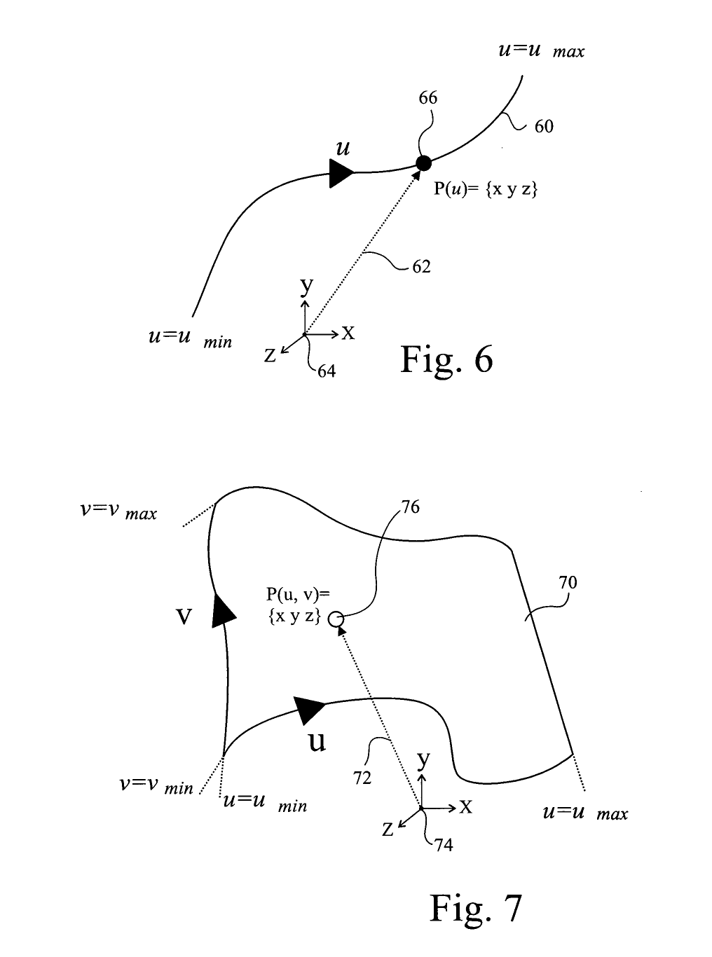

C(u) thus gives a vector from the origin to a point on the curve, and is therefore a vector-valued function. FIG. 6 shows an example of a parametric representation of a curve 60. For a certain value of u, the value of C(u) is a vector 62 from the origin 64 to a point 66 on the curve 60.

The parametric representation of a three-dimensional surface (such as the surface 32 shown in FIG. 4) is a vector valued function P(u, v) of two variables, or parameters, u and v:

$$P ( u , v ) = \{ \begin{matrix}x \\ y \\ z\end{matrix} \} = \{ \begin{matrix}x ( u , v ) \\ y ( u , v ) \\ z ( u , v )\end{matrix} \} , {u}_{min} \leq u \leq {u}_{max} , {v}_{min} \leq v \leq {v}_{max} \qquad ( 2 )$$

FIG. 7 shows an example of a parametric representation of a surface 70. For certain values of u and v, the value of P(u, v) is a vector 72 from the origin 74 to a point 76 on the surface 70.

NURBS is a further representation of a three-dimensional surface which can be used with the present invention. Other representations of three-dimensional surfaces can be used with the present invention.

In the following analysis, the first derivative of P with respect to u is denoted as P^{u}, the second derivative as P^{uu}, and so on.

The arc length s of a curve between points P(u₁) and P(u₂) is given by;

$$s = {\int }_{{u}_{1}}^{{u}_{2}} \sqrt{{P}^{u} \cdot {P}^{u}} \cdot ⅆ u \qquad ( 3 )$$

The principal normal vector at a point Pᵢ on a curve is given by:

$${E}_{3} = {P}_{i}^{uu} - \frac{{P}_{i}^{uu} \cdot {P}_{i}^{u}}{{‖ {P}_{i}^{u} ‖}^{2}} {P}_{i}^{u} \qquad ( 4 )$$

The surface normal vector at a point on the surface is given by the following expression in terms of the tangent vectors P^{u} and P^{v}:

$$n = \frac{{P}^{u} \times {P}^{v}}{‖ {P}^{u} \times {P}^{v} ‖} \qquad ( 5 )$$

Any curve C(t) mapped on the three-dimensional surface as P(u(t), v(t)) (with t as the parameter) may or may not have, at a given point on the curve, a principal normal vector which is the same as the surface normal vector at that point. The curvature of a curve lies along the curve's principal normal vector. The curvature of the curve C(t) can therefore be split into two components: normal curvature k_{N} (along the surface normal \vec{N}) and geodesic curvature k_{g} (along a tangential component n̅_{g} to the curve). These can be summed leading to a principal normal component k along the principal normal direction n̅_{c}:
k\vec{n}_{c}=k_{N}\vec{N}+k_{g}\vec{n}_{g} (6)

There are two fundamental forms of three-dimensional surface representation used in differential geometry. The first fundamental form is associated with the are length s of a curve on the surface:

$${s}^{2} = {‖ \frac{ⅆ s}{ⅆ t} ‖}^{2} = E {\dot{u}}^{2} + 2 F \dot{u} \dot{v} + G {\dot{v}}^{2} \qquad ( 7 )$$

where E=P^{u}·P^{u}, F=P^{u}·P^{v} and G=P^{v}·P^{v}, and are the coefficients of the first fundamental form. \dot{u} and \dot{v} are first derivatives of the surface parameters u(t) and v(t) with respect to the curve parameter t.

The second fundamental form is associated with the normal curvature of a surface curve:

$${k}_{N} = L {u}^{′ 2} + 2 M {u}^{′} {v}^{′} + N {v}^{′2} = \frac{L {\dot{u}}^{2} + 2 M \dot{u} \dot{v} + N {\dot{v}}^{2}}{E {\dot{u}}^{2} + 2 F \dot{u} \dot{v} + G {\dot{v}}^{2}} \qquad ( 8 )$$

where L=P^{uu}·N, M=P^{uv}·N and N=P^{vv}·N and are the coefficients of the second fundamental form. u′ and v′ are first derivatives of the surface parameters with respect to the arc length s such that:

$${u}^{′} = \frac{ⅆ u}{ⅆ s} = \frac{ⅆ u / ⅆ t}{ⅆ s / ⅆ t} = \frac{\dot{u}}{\sqrt{E {\dot{u}}^{2} + 2 F \dot{u} \dot{v} + G {\dot{v}}^{2}}} \qquad ( 9 )$$

The normal curvature k^{N} depends only on the direction of the curve at the point considered, and is the same for all curves tangent at that point. If a curve is a curve of intersection between a three-dimensional surface and a plane containing the surface normal N̅, then k_{g} is zero.

From equations (8) and (9), and rearranging [Mortenson], the principal curvature values k₁ and k₂ are found to be the roots of the following equation:
(EG−F²)k²−(EN+GL−2FM)k−(LN−M²)=0 (10)

The principal direction vectors (denoted \vec{d}₁ and \vec{d}₂) at a point on the surface are orthogonal to each other and both lie in a single plane tangent to the surface at that point. The principal direction vectors can therefore be specified as an angle θ from a reference direction, as other information about d̅₁ and d̅₂ can be derived from the tangent plane. Since the two tangent vectors P^{u} and P^{u} are not necessarily orthogonal, another reference direction must be used to achieve an orthonormal frame. A set of reference vectors \vec{e}₁ and \vec{e}₂ is used, given by:

$${\overline{e}}_{1} = \frac{{P}^{u}}{\sqrt{E}} , {\overline{e}}_{2} = \frac{{EP}^{v} - {FP }^{u}}{\sqrt{E ( EG - {F}^{2} )}} \qquad ( 11 )$$

The principal vectors \vec{d}₁ and \vec{d}₂ are then given by:
\vec{d}₁,\vec{d}₂=cos θ\vec{e}₁+sin θ\vec{e}₂ (12)

The angle θ is given by:

$$\begin{matrix}θ = {tan}^{- 1} \frac{B}{A} \\ where & ( 13 ) \\ A = \frac{L ( EG - 2 {F}^{2} ) + 2 EFM - {E}^{2} N}{2 E ( EG - {F}^{2} )} , B = \frac{EM - FL}{E \sqrt{EG - {F}^{2}}} & ( 14 )\end{matrix}$$

There are two solutions for θ in equations 13 and 14. Therefore equation 12 provides both principal direction vectors \vec{d}₁ and \vec{d}₂.

Further information can be found in Gallier, J. H. “Geometic methods and applications for computer science and engineering”, Dept of Computer and Information Science, University of Pennsylvania, USA, 2000 which is incorporated herein by reference in its entirety for all purposes.

An algorithm to calculate principal curves over a surface through the point 34 chosen in step 30 above can be implemented as follows, although other implementations are possible. Firstly, one of the principal direction vectors d̅₁ or d̅₂ is calculated. Next, a new point is determined on the surface a small increment in this direction from the point 34. The new point lies substantially on the line of curvature. The process is then repeated from the new point, finding the next point substantially on the line of curvature, until the edge of the surface is reached. The entire line is found by repeating the process from the point 34 and incrementing in the opposite direction. In this way, a line of curvature is calculated across the surface. An orthogonal line of curvature can be found by repeating the process and following the other principal direction.

Alternatively, the lines of curvature can be determined by solving the differential equations that define them:

$$\vert \begin{matrix}E & F & G \\ L & M & N \\ ⅆ {u}^{2} & - ⅆ u ⅆ v & ⅆ {v}^{2}\end{matrix} \vert = 0 \qquad ( 15 )$$

This equation can be transformed into a quadratic equation:

$$( FN - GM ) {( \frac{ⅆ v}{ⅆ u} )}^{2} + ( EN - GL ) ( \frac{ⅆ v}{ⅆ u} ) + ( EM - FL ) = 0 \qquad ( 16 )$$

The two differential equations resulting from equation 16 can be numerically solved to find points on the lines of curvature.

At umbilical points on a three-dimensional surface, magnitudes of the maximum an minimum curvatures are equal. The principal directions may therefore be undefined. Umbilical points can occur, for example, over a planar or spherical region on a three-dimensional surface.

When an umbilical point is detected, embodiments of the present invention decide to extend the curve “straight ahead”, for example along a geodesic direction, until a non-umbilical point is found. When the non-umbilical point is found, embodiments of the present invention continue to find points on the line of curvature.

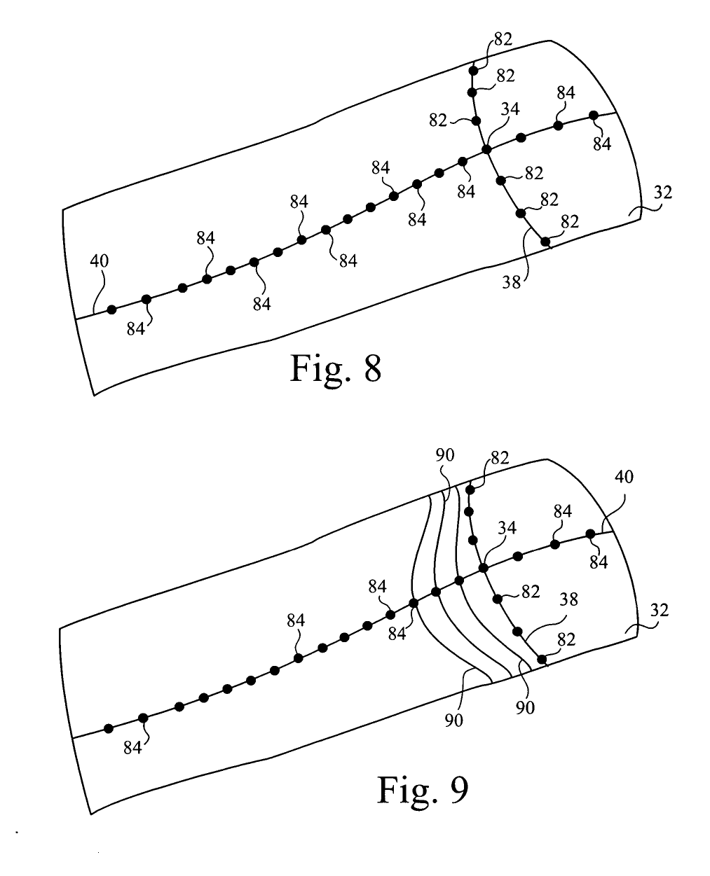

Referring back to FIG. 3, once the first and second generating curves 38 and 40 through the point 34 on the surface 32 have been determined in step 36, further points are defined on the first and second generating curves 38 and 40 in step 80. As shown for example in FIG. 8, a plurality of first points 82 is defined on the first generating curve 38, and a plurality of second points 84 is defined on the second generating curve 40. Therefore, on each of the generating curves 38 and 40, there are a plurality of points including the first point 34. The points defined on a curve in step 80 are preferably equally spaced along the curve, and preferably are spaced apart by approximately the desired length of a side of a cell on the three-dimensional surface. The cells on the three-dimensional surface correspond to panels and/or grid shell members of a structure constructed according to the three-dimensional surface. The spacing of the points may be in terms of, for example, the straight line distance between the points or the length of the curve between the points.

In step 86, which follows from step 80, a plurality of further curves is defined through the points defined on one of the generating curves in step 80. For example, as shown in FIG. 9, further curves 90 passing through the points 84 on the second generating curve 40 are determined. These curves are preferably lines of curvature, although in alternative embodiments one or more types of curve may be used. Only a small number of further curves 90 are shown in FIG. 9. However, each of the points 84 has a further curve 90 passing though it.

Referring back to FIG. 3, in step 92, which follows from step 86, a plurality of cells are determined on the three-dimensional surface 32. Cells are polygons (although not necessarily planar polygons) which, when put together or assembled, correspond substantially to the three-dimensional surface.

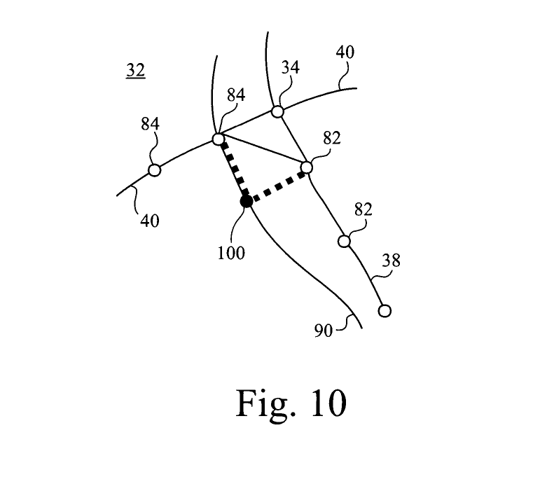

One example of a process for determining cells on the three-dimensional surface 32 is as follows. For three adjacent points determined in steps 30 or 80 in FIG. 3, a fourth point is determined, thus a four-sided cell with corners at the four points. The three adjacent points must not all lie on or substantially on a single curve. Therefore, at least two of the points must lie on or substantially on different curves in a first set of curves, where the first set of curves comprises the curves 38 and 90. For example, as shown in FIG. 10, the three adjacent points comprise the first point 34, one of the points 82 on the first generating curve 38, and one of the points 84 on the second generating curve 40. These three points 34, 82 and 84 lie in a single plane. Where this plane intersects a curve determined in step 86 (in the example shown in FIG. 10, this curve is the further curve 90 which passes through the point 84), the fourth point 100 is defined. Thus a cell is determined with corners at the points 34, 82, 84 and 100.

The fourth point 100 can now be used as one of the three adjacent points for finding a fourth point of a further cell. In the example shown in FIG. 10, a fourth point can be found where the three adjacent points are the point 100 and two of the points 82 on the first generating curve 38. A fourth point can also be found where the three adjacent points are the point 100 and two of the points 84 on the second generating curve 40. These new points can also be used to find further fourth points in further cells, and so on until the entire surface has been converted into cells. At the edges of the surface, for example, triangular cells can be used so as to avoid a jagged edge.

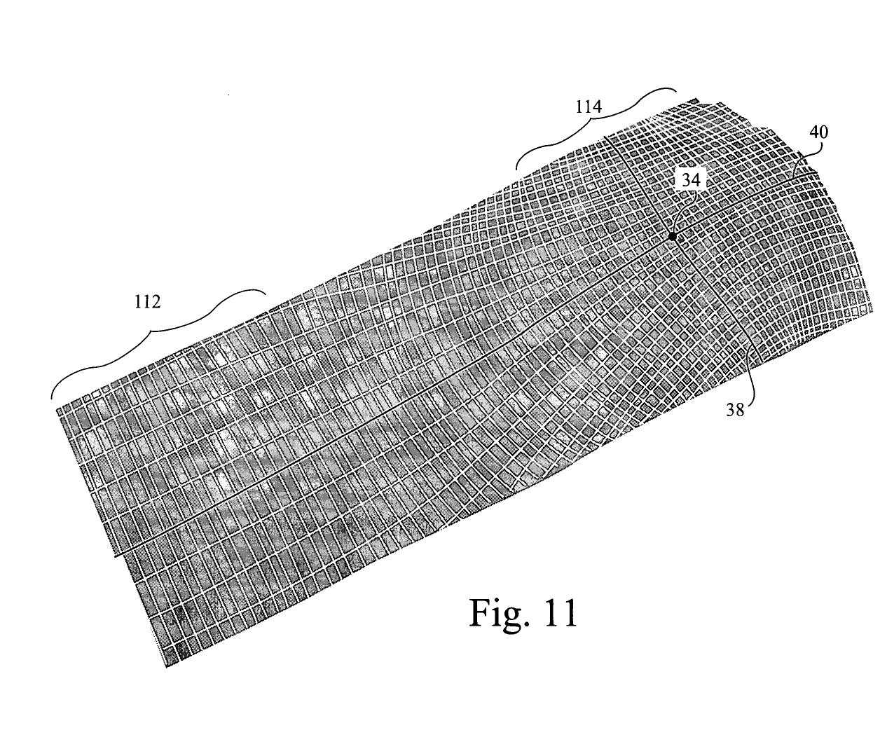

FIG. 11 shows an example of the surface 32 when converted into cells using the above described method. Each of the cells comprises a plane. This is particularly useful when, for example, a structure is constructed conforming substantially to the shape of the three-dimensional surface and where the cells are replaced by panels, for example panels of glass. Planar panels are less costly than non-planar panels and therefore the resulting structure is less costly to construct, and panels in the structure are less costly to replace. Furthermore, although planar glass panels can be distorted slightly (for example, a few degrees out of plane) to form non-planar glass panels, the panels may be under strain and therefore may be less desirable in a structure than planar glass panels.

Each cell comprises corners at four points. These points are further points, although some cells have points on the first generating curve, and some cells have points on the second generating curve (the starting point is considered to be a point on both the fast and second generating cures).

It can be appreciated that a bidirectional grid has been defied on the three-dimensional surface. A bidirectional grid is a grid comprising two sets of curves, where curves from one set cross lines of the other set, and vice versa.

Referring back to FIG. 3, once the cells have been determined in step 92, the cells are optimised in step 110. Optimisation of the cells recognises that there can be a density variation (and therefore also a size variation) of the cells across the surface. For example, as shown in FIG. 11, it can be appreciated that the cells in a first region 112 are generally larger than cells in a second region 114 across the surface. Therefore, the density of the cells is lower in the first region 112 and higher in the second region 114. Certain cells in the second region 114 can be merged and/or rearranged to make larger cells, so that there is a more uniform density variation of cells across the surface.

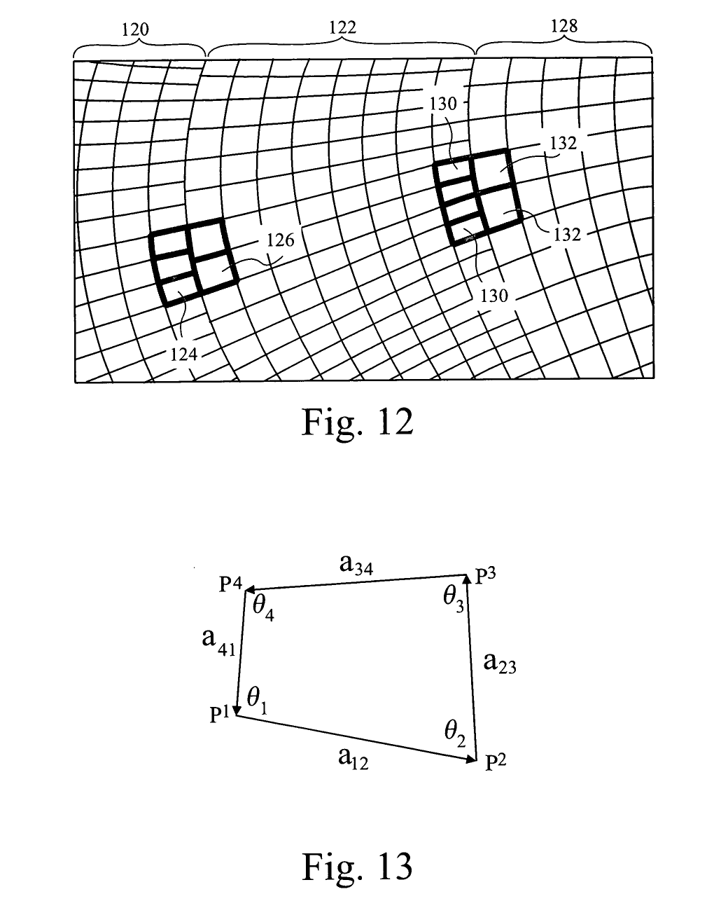

As shown for example in FIG. 12, a surface has a first region 120 containing a number of cells. Before optimisation, the cells in a second region 122 would have a higher density than those in the first region 120. Therefore, groups of three consecutive cells have been merged to form two cells. For example, the three cells 124 in the first region 120 would be adjacent to three cells in the second region 122 without optimisation. Instead, they are adjacent to two larger cells 126 in the second region 122 after optimisation.

Similarly, in a third region 128 on the surface, the density of the cells would be higher still without optimisation. Therefore, cells in the third region 128 are merged in the same way as cells in the second region 122 to form merged cells. In addition, pairs of merged cells are merged to make one larger cell. For example, a pair of cells 130 in the second region 122 is adjacent to a larger cell 132 in the third region 128.

Referring back to FIG. 3, once the cells have been optimised in step 110, the quality of the cells is calculated in step 136. A number of quality parameters can be calculated, including shear angle, aspect ratio, warp angle, offset and warp factor.

To reduce the cost of the structure to be constructed, especially if panels such as glass panels are to be used, it is desirable for each four-sided cell to have the following properties:
shear angle (deviation of corner angles from 90°) is as small as possible
aspect ratio (ratio of the longest side to the shortest side) as close to 1 as possible
warp angle (the degree of distortion of the cell out of a plane) is as small as possible, and preferably 0°
offset (distance of a point, or corner, of a cell from the plane defined by the other three points in the cell) is as small as possible, and preferably 0
warp factor (offset divided by the square root of the cell area) as close to 0 as possible

FIG. 13 shows a typical four-sided cell with four corner points p₁, p₂, p₃ and p₄. The internal angle of these points is θ₁, θ₂, θ₃ and θ₄ respectively. The vector from point p₁ to point p₂ is a₁₂, from p₂ to p₃ is a₂₃, from p₃ to p₂ is a₃₂ and so on.

The shear angle can be calculated as:

$$Shear = abs ( \frac{π}{2} - {cos}^{- 1} ( {a}_{12} \cdot {a}_{23} ) ) \qquad ( 17 )$$

The aspect ratio is calculated as the magnitude of the longest vector over the magnitude of the smallest vector:

$$Aspect ratio = \frac{max ( {a}_{12} , {a}_{23} , {a}_{34} , {a}_{41} )}{min ( {a}_{12} , {a}_{23} , {a}_{34} , {a}_{41} )} \qquad ( 18 )$$

The warp angle is calculated as:

$$Warp angle α = {cos}^{- 1} \frac{( {a}_{12} \times {a}_{14} ) \cdot ( {a}_{32} \times {a}_{34} )}{‖ ( {a}_{12} \times {a}_{14} ) \cdot ( {a}_{32} \times {a}_{34} ) ‖} \qquad ( 19 )$$

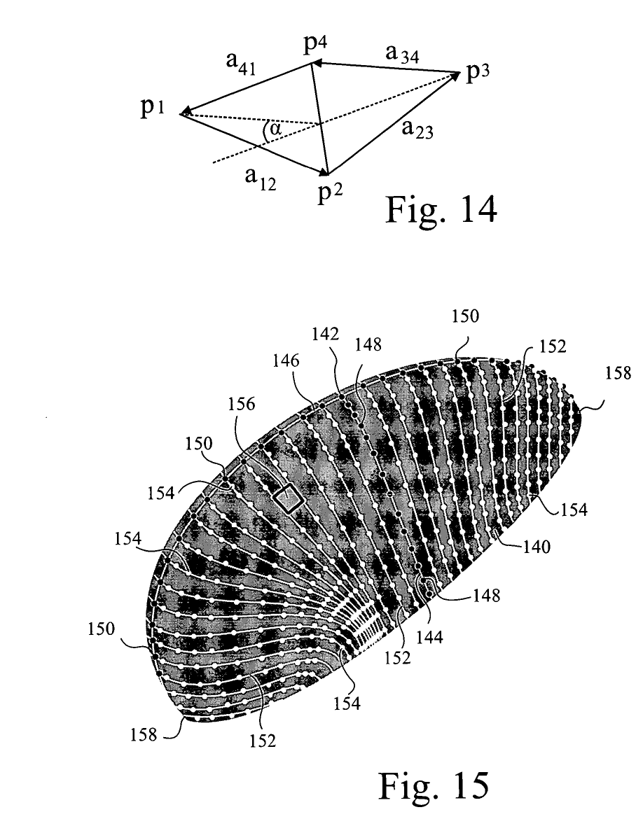

The warp angle is the angle between the two planes defined by the four points of a cell. FIG. 14 shows a cell which is non-planar. A first plane is defined by points p₁, p₂ and p₄. A second plane is defined by points p₂, p₃ and p₄. The warp angle is the angle α between the first and second planes as shown.

The offset is calculated as the distance between a plane defined by three points (and expressed as Ax+By+Cz+D=0) and the fourth point (x₄, y₄, z₄):

$$Offset = \frac{{Ax}_{4} + {By}_{4} + {Cz}_{4} + D}{\sqrt{{A}^{2} + {B}^{2} + {C}^{2}}} \qquad ( 20 )$$

The warp factor is calculated as:

$$Warp factor = \frac{Offset}{\sqrt{Area}} \qquad ( 21 )$$

Any one or more of the above quality parameters may be calculated in step 136.

In step 138, which follows from step 136, a user decides whether or not the three-dimensional surface has been mapped into acceptable cells. This can be done, for example, by inspecting the quality parameters calculated in step 136 for each of the cells, or for the “worst case” cell or cells in the plurality of cells (i.e. the cell or cells which have the worst quality parameters). Additionally or alternatively, the user can be presented with a graphical display of the cells, similar to that shown in FIG. 11. The user can then visually inspect the cells, which may include interacting with the cells, for example by rotating the point of view. If the user decides that the quality is acceptable, the process shown in FIG. 3 ends.

If the user decides that the quality is unacceptable, the process returns to step 30. The user will then be able to alter one or more factors that affect the cells, such as, for example, the type or types of curve used and/or the position of the starting-point 34, in an attempt to produce a more acceptable plurality of cells. Additionally or alternatively, the factors may be altered automatically.

Certain steps in the process shown in FIG. 3 may be optional, for example the step 110 of optimising the cells, and/or the step 136 of calculating quality parameters of the cells.

FIG. 15 shows another example of a three-dimensional surface 140. A first point 142 has been chosen in step 30 (shown in FIG. 3). First and second generating curves 144 and 146 (which are lines of curvature) have been defined in step 36. In step 80, points 148 have been defined in the first curve 144, and points 150 have been defined on the second curve 150. In step 86, further curves 152 have been defined passing through the points 150 on the second curve 146, and are also lines of curvature. The surface 140 shown in FIG. 14 also shows points 154 on the further curves 152. The points 154 are found in step 92 when determining cells on the surface 140, such as a cell 156.

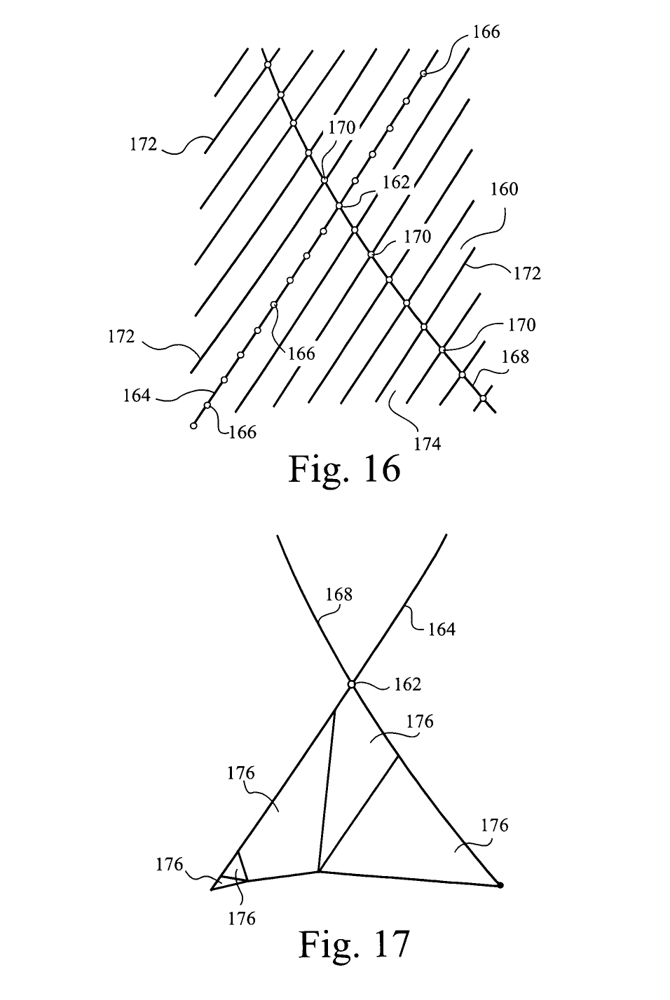

The above described process may not produce an acceptable plurality of cells, even when various first points 34 are used. FIG. 16 shows an example of a portion of a three-dimensional surface 160. In the process of FIG. 3, a first point 162 is defined in step 30. A first generating curve 164 is defined in step 36 with a plurality of points 166 defined thereon in step 80. A second generating curve 168 is defined in step 36 with a plurality of points 170 defined thereon in step 80. A plurality of further curves 172 are defined in step 86 which pass through the points 170. FIG. 17 shows the cells defined in step 92 in the area 174 below the first and second generating curves 164 and 168 on the surface 160. Other cells are not shown for clarity purposes. The area has been converted into a small number of cells 176, some of which are relatively large. This is because the conversion of the surface into cells requires that the cells are planar. The step 92 of determining cells on the surface therefore finds only a small number of points where the plane defined by three adjacent points intersects one of the further curves 172.

Certain embodiments of the present invention recognise that panels in a structure, including glass panels, can undergo a small amount of out-of-plane bending, so that they are slightly non-planar cells. It is therefore not necessary that the cells defined in step 92 are strictly planar. Therefore, in certain embodiments of the invention, the user is able to specify that the cells need not be strictly planar. For example, embodiments of the invention allow the user to specify that in step 92, for tree adjacent points, a fourth point is determined where the plane defined by the three adjacent points passes within a predetermined distance (for example, a distance specified by the user) of one of the further curves defined in step 86 of FIG. 3.

The user may, for example, specify the predetermined distance in a number of ways, such as, for example, by specifying the predetermined distance itself, or by specifying a maximum value for the warp angle, offset or warp factor calculated in step 136 of FIG. 3. For example, the user may specify a maximum warp angle (see equation 19 above), and the software according to embodiments of the invention will iteratively search for a panel which has a size closest to the desired size. The iterative procedure begins by mapping the fourth point at the desired distance from the known points on the generating curves. The property (eg warp angle) of the resulting panel is then determined and checked if it is within the acceptable limits. If not, the process is repeated by searching the fourth point in the neighbourhood of the one already determined.

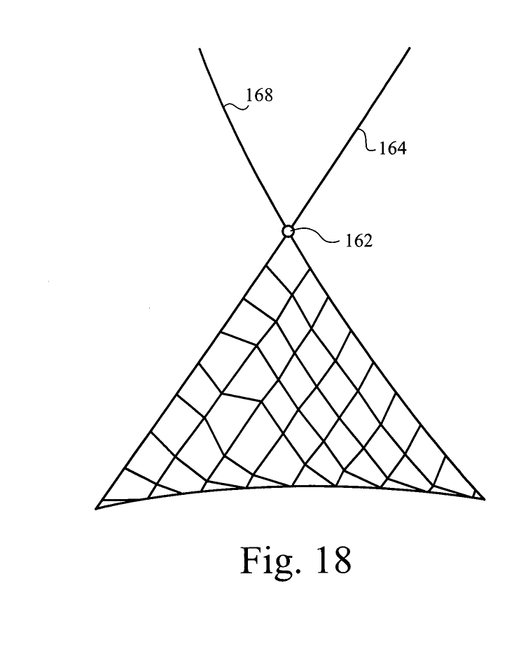

FIG. 18 shows the area 174 on the surface 160 which has been mapped such that slightly non-planar cells have been determined. Comparing this to FIG. 17, it can be appreciated that the panels in FIG. 18 are of a more acceptable, more uniform size and are more uniformly distributed across the area 174.

In alternative embodiments of the invention, the cells are determined in step 110 of FIG. 3 such that they have corners at intersection points were two sets of curves intersect on the three-dimensional surface. Therefore, for example, in step 86, a first set of curves is defined passing through points on the second generating curve as above. However, in addition, a second set of curves is also defined in step 86, passing through points on the first generating curve defined in step 80. For example, the first and second sets of curves are lines of curvature, and intersect at right angles to each other. Intersection points are defined at the points where the curves intersect. The cells determined in step 110 are therefore cells with corners at the intersection points and points defined in steps 30 and 80, and the edges of the cells are straight lines between the points.

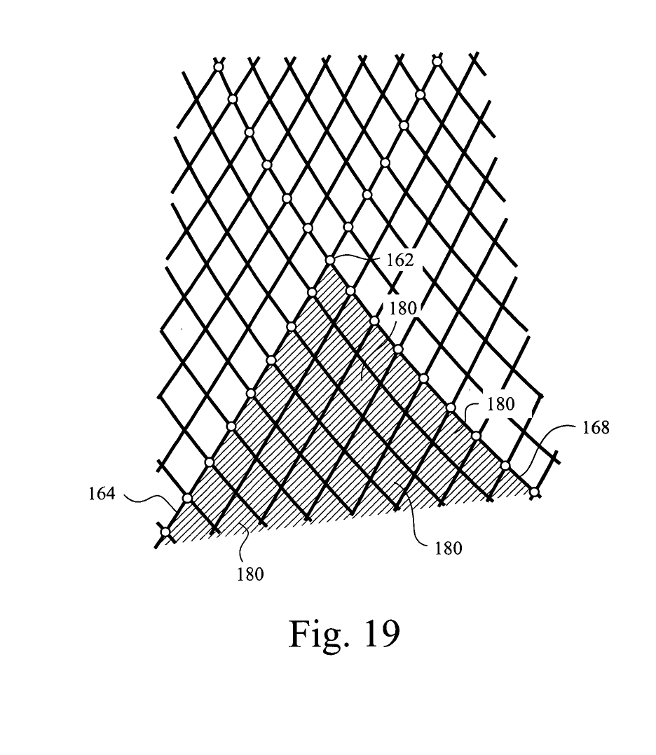

For example, as shown in FIG. 19, the area 174 on the surface 160 of FIG. 16 has been converted to cells which have corners at intersection points. It can be appreciated that the cells have a more uniform size and shape to those cells shown in FIG. 18. This method however may produce cells with a larger warp angle, offset and/or warp factor than other methods described. However, the warp angle, offset and/or warp factor may still be within acceptable limits.

In certain embodiments, one or more of the generating curves and/or one or more of the further curves defined in step 36 and/or step 86 are not lines of curvature.

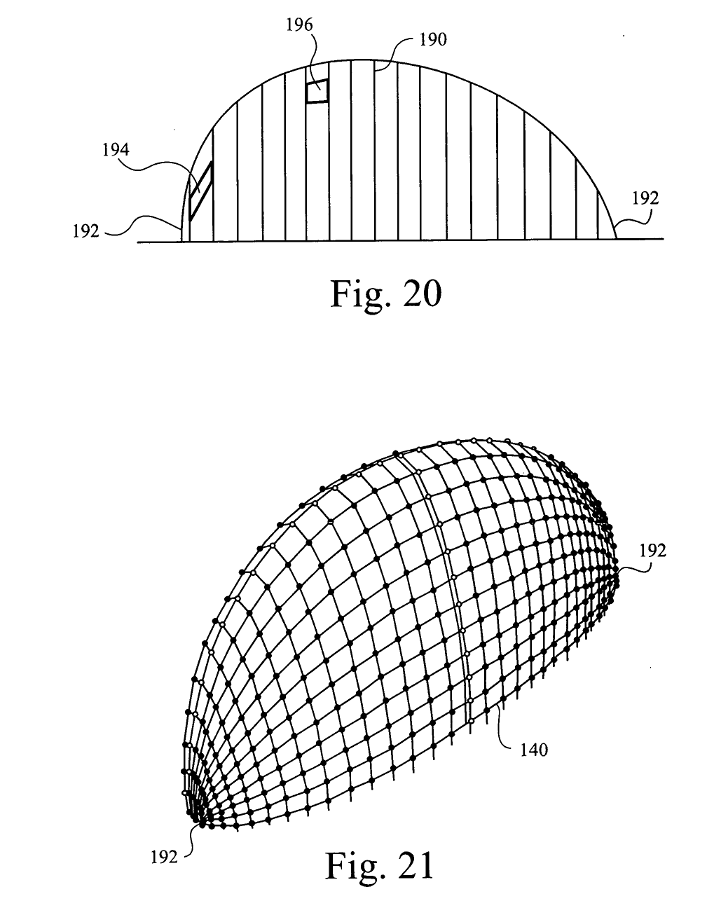

In certain embodiments, one or more of the curves defined in step 36 and/or 86 comprise a line of intersection between the surface and a plane. For example, FIG. 20 shows a side view of the surface 140 of FIG. 15. In steps 30, 36, 80 and 86 of FIG. 3, a plurality of curves 190 are defined on the surface. Each curve 190 is a curve of intersection between the surface 140 and a vertical plane. The planes forming the curves 190 are, in the example shown, equally spaced parallel planes, although in certain embodiments the planes need not be equally spaced and/or parallel. The second generating curve defined in step 36 may be any type of curve such as, for example, a line of curvature or a curve of intersection with a further vertical plane. The points defined on the second curve in step 80 are points where the second curve intersects one of the vertical planes (i.e. points where the second curve intersects one of the curves 190). The surface 140 may then be converted into cells using the remaining steps 92, 110 and 136 of FIG. 3 as above, or by any other method according to embodiments of the invention.

A planar curve can be mapped onto a three-dimensional surface by simultaneously solving the equation of the surface (see equation 2 above) with that of a plane. The equation of a plane is given by

$$\begin{matrix}Ax + By + Cz + D = 0 & ( 22 ) \\ and & \\ d = [ \begin{matrix}\frac{AD}{{A}^{2} + {B}^{2} + {C}^{2}} & \frac{BD}{{A}^{2} + {B}^{2} + {C}^{2}} & \frac{CD}{{A}^{2} + {B}^{2} + {C}^{2}}\end{matrix} ] & ( 23 )\end{matrix}$$

where d is the direction vector along the plane normal and through the origin.

For a plane intersecting the three-dimensional surface, the scalar product of d with the vector [P(u,v)−d] lying in the plane must equal zero:
[P(u,v)−d]∘d=0 (24)

This can be solved to find the equation of the intersecting curve.

In the example shown in FIG. 20, cells near one of the ends 192 may be large compared to cells in other areas of the surface. Additionally or alternatively, for example, the aspect ratio of one or more cells may be considerably larger or smaller than the desired value (for example 1), and/or other quality parameters may lie outside of acceptable limits. Therefore, in order to make the cells of a comparable size across the surface 140, and/or to improve the quality parameters of at least some of the cells, the vertical planes making the curves 190 may be unequally spaced, and spaced closer together towards the ends 192 of the surface 140. FIG. 21 shows the surface 140 converted into cells where the vertical planes are closer together towards the ends 192. Large cells occurring towards the ends 192 are avoided. However, the density of the cells is high around the ends 192. This may be difficult to construct, and if the cells are converted into glass panels, the density of the supporting structure and edges of the panels towards the ends 192 will result in a structure which is difficult to see though towards the ends 192. This may be avoided at least in part by making use of cell merging in step 110. It can be seen that, as shown in FIG. 14, when lines of curvature are used as the further curves this problem is avoided, and it can be appreciated that a resulting glass panel structure will not have such dense panels at the ends 192 when lines of curvature are used.

In certain embodiments, at least some of the curves defined in step 36 and/or 86 are isoparametric curves. Isoparametric curves are parametric curves used to define the three-dimensional surface (for example a NURBS surface) before it is obtained in step 20 of FIG. 2. These are the curves for which one of the two defining parameters (u and v) of the surface are constant. Two families of isoparametric curves exist to define the surface: P(u, v=v_{c}) and P(u=u_{c}, v) where u_{c} and v_{c} are constants.

A parametric cylinder is defined by sweeping a circle (cross-section) along a straight line (axis). Both these curves are modelled using one parameter each (say u for the circle and v for the line). The resulting surface is then fully defined by these two parameters. Therefore u=const defines a straight line on the surface whereas v=const defines a circle. By varying the value of const a series of bidirectional curves is generated, which are the isoparametic curves. Other examples of isoparametric curves might include, for example, circles along the smaller and larger circumferences of a torus.

In certain embodiments, one or more the curves defined in step 36 and/or 86 comprise a geodesic curve. A geodesic curve is a curve that follows the shortest distance on the three-dimensional surface between two points on the surface. In other words, a geodesic curve goes “straight ahead” without deviating from its path on the surface. From every point on a surface, depending upon which direction one shoots off at, an infinite number of geodesic curves exit. A characteristic of the geodesic curve is that the geodesic curvature k_{g} is zero everywhere.

Having regard to the equation of the surface (see equation 2 above), the equation of a geodesic is given by:

$$\begin{matrix}\frac{\frac{\partial A}{\partial v} + 2 {v}^{′} \frac{\partial B}{\partial v} + {v}^{′ 2} \frac{\partial C}{\partial v}}{2 \sqrt{A + 2 {Bv}^{′} + {Cv}^{′ 2}}} - \frac{ⅆ}{ⅆ u} ( \frac{B + {Cv}^{′}}{\sqrt{A + 2 {Bv}^{′} + {Cv}^{′ 2}}} ) = 0 & ( 25 ) \\ where , & \\ A = ‖ \frac{\partial P}{\partial u} ‖ = \sqrt{{( \frac{\partial x}{\partial u} )}^{2} + {( \frac{\partial y}{\partial u} )}^{2} + {( \frac{\partial z}{\partial u} )}^{2}} & ( 26 ) \\ B = \sqrt{\frac{\partial x}{\partial u} \frac{\partial x}{\partial v} + \frac{\partial y}{\partial u} \frac{\partial y}{\partial v} + \frac{\partial z}{\partial u} \frac{\partial z}{\partial v}} & ( 27 ) \\ C = ‖ \frac{\partial P}{\partial v} ‖ = \sqrt{{( \frac{\partial x}{\partial v} )}^{2} + {( \frac{\partial y}{\partial v} )}^{2} + {( \frac{\partial z}{\partial v} )}^{2}} & ( 28 )\end{matrix}$$

The above differential equation is numerically solved to yield the points on the geodesic curve.

In certain embodiments, one or more of the curves defined in step 86 comprise a “parallel curve” which is “parallel” to another curve on the three-dimensional surface (such as, for example, one of the generating curves or another one of the further curves).

A parallel curve is a derived curve, in that it is derived from another curve. A parallel curve is formed on the three-dimensional surface by taking a copy of another curve on the three-dimensional surface, translating it in space, and then projecting it onto the three-dimensional surface.

The steps to be taken to determine a parallel curve parallel to a first curve (which can be any curve on the surface such as a generating curve or a further curve) are as follows:
1. Choose a starting point on the first curve (called the local first curve point), and a point on the surface which is to be the corresponding point on the parallel curve (called the local parallel curve point).
2. Calculate the surface normal at the local first curve point, and the tangent to the first curve at the local first curve point. Define a plane (called the local intersecting plane) containing these two vectors.
3. Translate the local intersecting plane to the local parallel curve point.
4. Find the curve of intersection between the local intersecting plane and the surface. Choose a point on the curve of intersection which is close to the local parallel curve point. This is the new local parallel curve point.
5. Choose another point on the first curve close to the local first curve point. This is the new local first curve point.
6. Repeat steps 2 to 5 until the edge of the surface is reached. The local parallel curve points all lie on the parallel curve. These points can therefore be joined to form the parallel curve.

The process may also be repeated, but moving in the opposite direction, so that a full curve is formed which extends between two edges of the surface (although the two edges may be the same edge for certain curves).

The local normal vector n on the surface is given by equation 5 above. The local first curve tangent (a vector) is given by;

$${E}_{I} = \frac{{P}_{l}^{u}}{‖ {P}_{i}^{u} ‖} \qquad ( 29 )$$

These two vectors define the local intersecting plane:
(P^{u}×P^{v})·(P−P₁)=0 (30)
where P₁ is the local first curve point that is being considered.

In certain embodiments, equal mesh net generation (also called draping) is used to define cells on the three-dimensional surface. Equal mesh net generation defines cells where edges of the cells correspond substantially to fibres of a fabric which is theoretically forced to conform to the three-dimensional surface. The cells always have edges of fixed (i.e. predetermined) lengths.

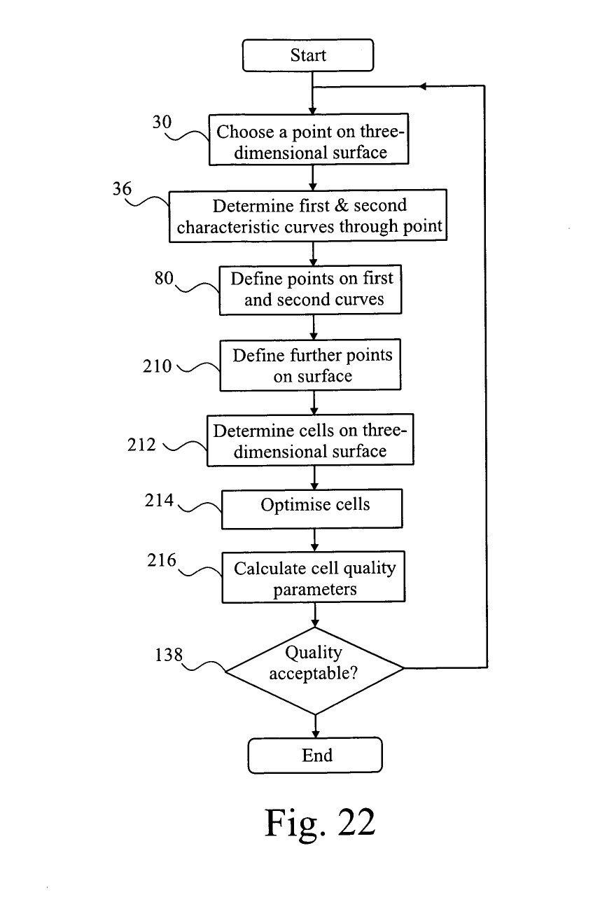

FIG. 22 shows a flow chart of a process of converting a three-dimensional surface into cells using equal mesh net generation. Where steps are the same as those shown in FIG. 3, they are given the same reference numerals.

As shown in FIG. 22, the steps 30, 36 and 80 are carried out to define a plurality of points on first and second generating curves on the surface. The points on any one curve are preferably equally spaced such that the cells produced have equal length sides.

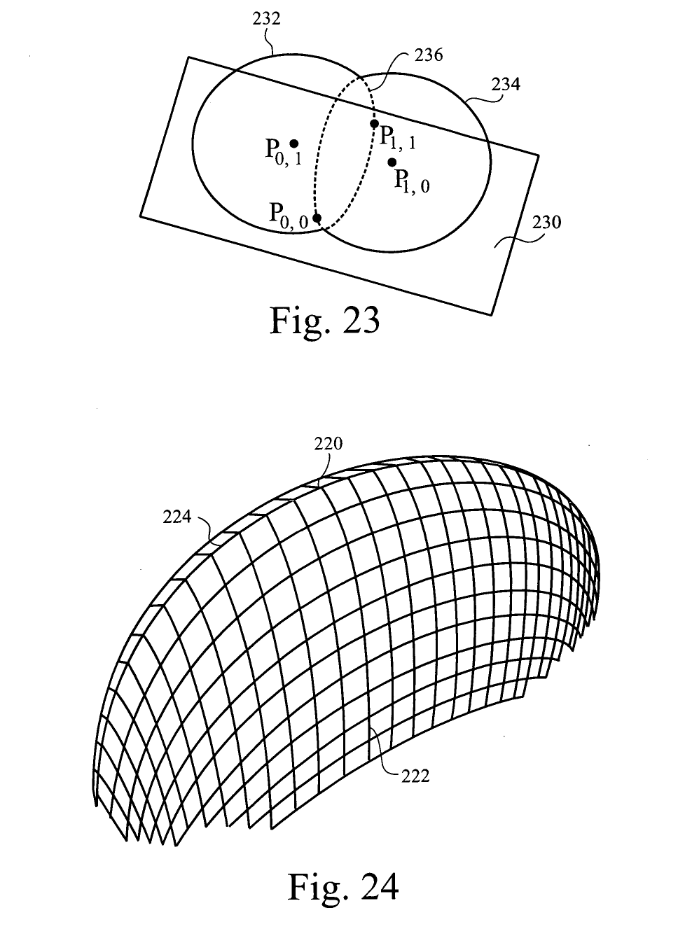

Step 210 follows from step 80. In step 210, a plurality of further points is defined on the three-dimensional surface. This is illustrated in FIG. 23, which shows a part 230 of a three-dimensional surface. Three adjacent points (from the points determined in step 30 or 80) are considered (referred to as P_{0,0}, P_{0,1} and P_{1,0}) and a further point (referred to as a fourth point P_{1,1}) is defined as follows. The adjacent points P_{0,0} and P_{0,1} have a fixed separation distance, being the length of one of the edges of each cell. The adjacent points P_{0,0} and P_{1,0} will also have a fixed separation distance, being the length of another of the edges of each cell. Two spheres are considered, one having its centre at P_{0,1} and a radius of the distance between the points P_{0,0} and P₀,1. The other sphere has its centre at P_{1,0} and a radius of the distance between the points P_{0,0} and P_{1,0}. The spheres intersect to form a circular curve of intersection 236. The circular curve will intersect the three-dimensional surface 230 at two points. One of these points will be substantially at the point P_{0,0}. The other will be the fourth point, denoted P_{1,1}. Because the fourth point is determined where the circular curve of intersection intersects the three-dimensional surface, the fourth point P_{1,1} will always be a fixed distance from the point P_{1,0} and a fixed distance from the point P_{0,1}.

In step 212, which follows from step 210, a plurality of cells are determined which have corners at the points found in steps 30, 80 and 210.

FIG. 24 shows the example surface of FIG. 15, when converted into cells using equal mesh net generation. A starting point 220 is chosen in step 30. First and second generating curves 222 and 224 are determined in step 36. In the example shown in FIG. 24, the generating curves are lines of curvature, although other curves can be used. The cells have fixed length sides. Towards the edges of the surface, no fourth point is found which lies on the surface. There are therefore jagged edges shown in FIG. 24. These can be resolved, for example, by defining cells at the edges which are triangular or do not have equal length sides.

Referring back to FIG. 22, in step 214, which follows from step 212, the cells determined in step 212 are optimised. This may include, for example, merging of panels in high-density areas as described above.

In step 216, which follows from step 214, quality parameters of the cells determined in step 212 are calculated. The quality parameters which are calculated are the shear angle (see equation 17 above) and shear deformation factor. The shear deformation factor is the ratio of the area of a cell to the area of a cell with the same length sides but with corners of 90°.

The aspect ratio of the cells is not determined as it is the same for all cells. The warp angle, offset and/or warp factor may additionally or alternatively be calculated, as the equal mesh net generation algorithm does not necessarily find planar cells.

In step 138, which follows from step 216, the user decides whether or not the cells are acceptable. This can be done, for example, by visual inspection of a graphical display of the cells and/or consideration of the quality parameters determined in step 216.

In step 136 (both in FIG. 3 and FIG. 22), the decision whether or not the quality is acceptable can be made automatically instead of by a user. For example, if the maximum shear angle is greater than an acceptable threshold, the process can be restarted from step 30 automatically.

In certain embodiments, the cells determined in step 212 of FIG. 22 have sides of equal length. Each cell can therefore be regarded as a square which may be sheared and/or bent out of plane. In alternative embodiments, the cells can have sides of unequal length. In this case, the radii of the spheres 232 and 234 having respective centres at points P_{1,0} and P_{0,1} are not equal, and each fourth point P_{1,1} is not an equal distance from the two points P_{1,0} and P_{0,1}. In this case, each cell can be regarded as a rectangle (or any other polygon) which may be sheared and/or bent out of plane.

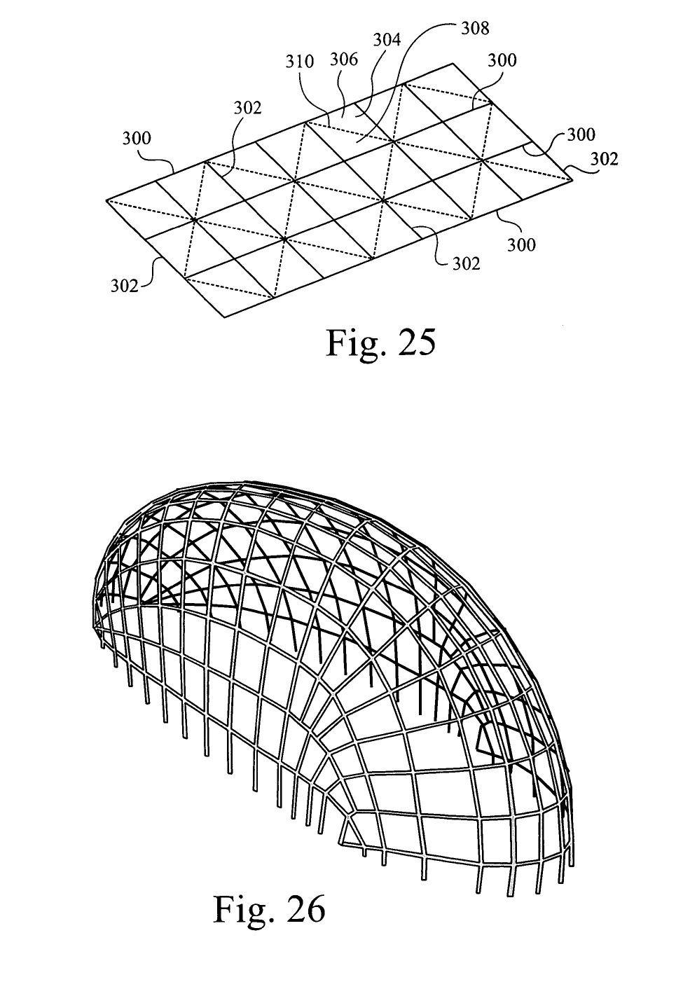

In certain embodiments, a technique called “triaxial mapping” is used on the cells. With triaxial mapping, each 4-sided cell is divided into two triangular cells by connecting two opposite corners of the cell. Each triangular cell is planar, even if the divided cell is non-planar. FIG. 25 shows an example of cells corresponding to a portion of a three-dimensional surface to which triaxial mapping has been applied. Any of the methods described above is used to produce a bidirectional grid of cells, arising from a first set of curves 300 (which may include one of the generating curves) and a second set of curves 302 (which may include the other generating curve). Each cell, for example cell 304, has been divided into two triangular cells 306, 308 using a dividing line 310. The dividing lines are arranged such that where a dividing line in a cell ends at a corner, cells which share the same corner point (i.e. three other cells in a bidirectional grid) also have an end of the dividing line at the corner point. Thus, as shown in FIG. 25, the dividing lines effectively form another bidirectional grid. Other implementations are possible, for example where the dividing lines are generally “parallel” and form a set of lines which do not intersect each other.

Triaxial mapping reduces the size of the cells. Cells which are generally too small can be avoided by specifying that the cells produced using methods according to embodiments of the invention (such as, for example, those shown in FIGS. 3 and 22) should be larger.

Methods which create a bidirectional grid from curves on the three-dimensional surface, such as a method using two intersecting sets of lines of curvature as described above, can also be used with triaxial mapping. The intersection points on the grid can simply be connected with straight lines to form a 4-sided cell which can then be split into two triangular cells as described above.

In certain embodiments, a method called “planarisation” is applied to the cells. Planarisation is a method of adjusting non-planar cells such that they become planar. An example of a method of planarisation is described below:
1. Set the status of points on the generating curves to “moved”. Set the status of all other points to “unmoved”,
2. For a cell with three “moved” points and one “unmoved” point, define a plane through the three “moved” points.
3. Determine a surface normal on the three-dimensional surface at the “unmoved” point.
4. Find the point of intersection between this normal and the plane determined in step 3.
5. Move the “unmoved” point to the intersection point found in step 4, and set its status to “moved”.
6. Repeat steps 2 to 5 until all points have been set as “moved”.

The first cells that have three “moved” points are the four cells that include the starting point as one of the points of the cell, as only these cells have three “moved” points. As points are moved, other cells become cells which have three “moved” points.

In certain embodiments, instead of providing cell data, the software according to embodiments of the invention provides data on a plurality of points identified or found on the surface. This data on a plurality of points may be used accordingly, for example the data may be used as corners of a plurality of panels when constructing a structure according to the three-dimensional surface. In certain embodiments, a user may be able to specify the type of data which is provided, for example whether data is provided on a plurality of cells or a plurality of points.

A structure can be constructed according to the cells determined using the above described methods, scaling as appropriate and replacing the cells with panels (for example, glass panels). Alternatively, a grid shell structure can be constructed whereby the cells are scaled as appropriate and edges of the cells are replaced with grid shell members. The shape of the structure will conform substantially with the shape of the three-dimensional surface. FIG. 26 shows an example of a grid shell structure conforming substantially to the shape of the surface 140 of FIG. 15 when the cells are converted to grid shell members.

In certain embodiments, when a structure is constructed according to the cells, the cells in the structure do not necessarily have edges which match or share the edges of adjacent cells. For example, support members can be included in the structure which support corners of adjacent cells, where the corners are not substantially at the same point. This may give the structure an uneven look, although the effect may not be noticeable if the corners of adjacent cells are offset by only small amounts, and/or the structure is large enough for the corners to be a significant distance from the viewer. This technique could be used to allow planar panels to be used in a structure where the determined cells are non-planar.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

1. A method of determining points on a three-dimensional surface, comprising:
determining a plurality of first points on a first curve on the surface; determining a plurality of second points on a second curve on the surface; determining a further point in a set of further points, wherein the further point is associated with associated points, and the associated points comprise at least two points from the plurality of first points, the plurality of second points and/or the set of further points.

2-39. (canceled)

40. A method as claimed in claim 1, comprising determining a plurality of further points associated with respective associated points.

41. A method as claimed in claim 1, wherein determining a further point comprises determining a point on or within a predetermined distance of the surface which is also on a plane defined by the associated points, where the associated points comprise at least three points.

42. A method as claimed in claim 41, wherein determining a further point comprises determining a point on or within the predetermined distance of the surface where the plane intersects or passes within the predetermined distance of one of a first set of curves on the surface.

43. A method as claimed in claim 42, wherein each curve in the first set of curves passes through at least one of the first plurality of points.

44. A method as claimed in claim 41, wherein at least one curve of the first set of curves is one of a line of curvature and a curve of intersection between the three-dimensional surface and an intersecting plane,

45. A method as claimed in claim 1, wherein determining a further point comprises determining a point on or within a predetermined distance of a point where a curve of a first set of curves on the three-dimensional surface intersects a curve of a second set of curves on the three-dimensional surface.

46. A method as claimed in claim 45, wherein at least one curve of the first set of curves is one of a line of curvature and a curve of intersection between the three-dimensional surface and an intersecting plane.

47. A method as claimed in claim 45, wherein at least one curve of the second set of curves is one of a line of curvature, an isoparametric curve and a curve of intersection between the three-dimensional surface and an intersecting plane.

48. A method as claimed in claim 45, wherein determining a further point comprises determining a point on the three-dimensional surface which is a first predetermined distance from one of the associated points and a second predetermined distance from another of the associated points.

49. A method as claimed in claim 1, wherein at least one of the first and second curves is one of a line of curvature, an isoparametric curve, and a curve of intersection between the three-dimensional surface and an intersecting plane.

50. A method as claimed in claim 1, further comprising determining a plurality of cells where each cell has corners at or within a predetermined distance of respective ones of the first points, the second points, and the further points.

51. A method as claimed in claim 50, wherein each cell has four edges.

52. A method as claimed in claim 50, further comprising merging selected cells to form one or more larger cells.

53. A method as claimed in claim 50, further comprising providing, for at least one of the cells, an indication of at least one of deviation of corner angles from a predetermined angle, a ratio of longest edge to shortest edge of a cell, an angle between cell planes defined by the points at the corners of the cell, a distance of a corner of a cell from a plane defined by other corners of the cell, and the distance divided by the square root of the area of the cell.

54. A method as claimed in claim 50, further comprising defining a plurality of panels corresponding to the cells.

55. A method as claimed in claim 54, further comprising constructing a structure according to the panels.

56. A method as claimed in claim 50, further comprising defining a plurality of structure members corresponding to edges of the cells.

57. A method as claimed in claim 56, further comprising constructing a grid shell structure according to the structure members.

58. A method as claimed in claim 1, wherein the three-dimensional surface is a doubly curved surface.

59. A method as claimed in claim 1, wherein the method is a computer-implemented method.

60. A computer readable medium storing code which when executed on a computer performs the functions of: determining a plurality of first points on a first curve on the surface; determining a plurality of second points on a second curve on the surface; determining a further point in a set of further points, wherein the further point is associated with associated points, and the associated points comprise at least two points from the plurality of first points, the plurality of second points and/or the set of further points.

61. A method of constructing a three-dimensional structure, said method comprising the method of claim 57, and further comprising constructing a structure from at least one of panels having corners at the points and grid shell members having ends at the points.

62. A method of constructing a three-dimensional structure, said method comprising:
determining a plurality of first points on a first curve on a three-dimensional surface;
determining a plurality of second points on a second curve on the surface;
determining a further point in a set of further points, wherein the further point is associated with associated points, and the associated points comprise at least two-points from the plurality of first points, the plurality of second points and/or the set of further points; and
constructing a structure from at least one of panels having corners at structure points and grid shell members at structure points, where the structure points comprise points taken from at least one of the plurality of first points, the plurality of second points and the set of further points.

63. A method of determining a plan for a three-dimensional structure, comprising:
identifying a plurality of points on or within a predetermined distance of a plurality of points on the three-dimensional surface; and
converting the plurality of points into a plan of at least one of panels and grid shell members.

64. A method of producing a panel for a structure, comprising determining a shape of a panel from a plurality of points on a three-dimensional surface, and producing a panel according to the determined shape.

65. A method of producing a panel, said method comprising:
determining a plurality of first points on a first curve on a three-dimensional surface;
determining a plurality of second points on a second curve on the surface;
determining a further point in a set of further points, wherein the further point is associated with associated points, and the associated points comprise at least two points from the plurality of first points, the plurality of second points and/or the set of further points;
determining a shape of a panel from a plurality of points taken from at least one of the plurality of first points, the plurality of second points and the set of further points; and
producing a panel according to the determined shape.
